(19) United States
(12) Patent Application Publication
(10) Pub. No.: US 2014/0357489 A1
(43) Pub. Date: Dec. 4, 2014

(54) Emulsifiable concentrate comprising pesticide, dimethyl sulfoxide, benzyl alcohol, alkyl lactate

(71) Applicant: BASF SE, Ludwigshafen (DE)

(72) Inventors: Cedric Dieleman, Scheibenhard (FR); Winfried Mayer, Bubenheim (DE); Thomas Ottillinger, Schifferstadt (DE); Ralph Steinbacher, Bohl-Iggelheim (DE); Siegfried Strathmann, Limburgerhof (DE)

(73) Assignee: BASF SE, Ludwigshafen (DE)

(21) Appl. No.: 14/362,218

(22) PCT Filed: Nov. 14, 2012
(86) PCT No.: PCT/EP2012/072565

§ 371 Date: Jun. 2, 2014

Related U.S. Application Data
(60) Provisional application No. 61/608,130, filed on Mar. 8, 2012.
(60) Provisional application No. 61/566,739, filed on Dec. 5, 2011.

(51) Int. Cl. A01N 25/04; A01N 43/56

(52) U.S. Cl. CPC A01N 25/04; A01N 43/56
USPC 504/363; 514/406

(57) ABSTRACT

Subject matter of the present invention is an emulsifiable concentrate comprising a water-insoluble pesticide, benzyl alcohol, alkyl lactate and not more than 40% by weight of dimethyl sulfoxide. A further subject matter is an emulsion obtainable by mixing water with the emulsifiable concentrate; a process for the preparation of the emulsifiable concentrate; and a method for controlling phytopathogenic fungi and/or undesired vegetation and/or undesired attack by insects or mites and/or for regulating the growth of plants, where the concentrate or the emulsion is allowed to act on the respective pests, their environment or on the crop plants to be protected from the respective pests, on the soil and/or on undesired plants and/or on the crop plants and/or their environment.

Subject matter of the present invention is an emulsifiable concentrate comprising a water-insoluble pesticide, benzyl alcohol, alkyl lactate and not more than 40% by weight of dimethyl sulfoxide. A further subject matter is an emulsion obtainable by mixing water with the emulsifiable concentrate; a process for the preparation of the emulsifiable concentrate; and a method for controlling phytopathogenic fungi and/or undesired vegetation and/or undesired attack by insects or mites and/or for regulating the growth of plants, where the concentrate or the emulsion is allowed to act on the respective pests, their environment or on the crop plants to be protected from the respective pests, on the soil and/or on undesired plants and/or on the crop plants and/or their environment. The present invention comprises combinations of preferred features with other preferred features.

Emulsifiable concentrates (also referred to as emulsion concentrates or EC) are widely used formulations in crop protection. The disadvantage of the known emulsion concentrates is the poor cold stability, the pronounced tendency to crystallize and the low pesticide concentration.

It was an object of the present invention to provide an emulsion concentrate which overcomes these disadvantages.

The object was achieved by an emulsifiable concentrate comprising a water-insoluble pesticide, benzyl alcohol, alkyl lactate and not more than 40% by weight of dimethyl sulfoxide.

Usually, an emulsifiable concentrate is taken to mean compositions which form an oil-in-water emulsion upon mixing with water (e.g. in a weight ratio of 1 part concentrate to 99 parts water). The emulsion usually arises spontaneously. The resulting emulsion may have an average droplet size of more than 0.1 μm, preferably more than 0.5 μm, in particular more than 0.8 μm, and most preferred more than 1.1 μm. The resulting emulsion may have an average droplet size of up to 30 μm, preferably up to 10 μm, in particular up to 5 μm. The average droplet size may be determined by laser diffraction, e.g. with a Malvern Mastersizer 2000. Usually the resulting emulsion is not a miniemulsion, and not a microemulsion.

The concentrate is preferably present as a homogeneous solution. It is usually virtually free from dispersed particles.

Suitable alkyl lactates are aliphatic C₁-C18-alkyl lactates (in particular C6-C₁₀-alkyl lactates), which may be linear or branched. Examples are cyclohexyl lactate, 2-ethylhexyl lactate, 2-methylcyclohexyl lactate, heptyl lactate, octyl lactate, or mixtures of these. Especially preferred is 2-ethylhexyl lactate. The alkyl lactates can be present in the form of D- and/or L-lactates, with the L-lactates being preferred.

The concentrate can comprise not less than 10% by weight, preferably not less than 15% by weight, more preferably not less than 20% by weight and in particular not less than 30% by weight of alkyl lactate (such as 2-ethylhexyl lactate). The concentrate can comprise not more than 80% by weight, preferably not more than 65% by weight and in particular not more than 50% by weight of alkyl lactate (such as 2-ethylhexyl lactate).

The concentrate can comprise not more than 30% by weight, preferably not more than 20% by weight, more preferably not more than 15% by weight and in particular not more than 10% by weight of dimethyl sulfoxide (DMSO).

The concentrate can comprise not more than 50% by weight, preferably not more than 35% by weight and in particular not more than 28% by weight of benzyl alcohol. The concentrate can comprise not less than 3% by weight, preferably not less than 8% by weight and in particular not less than 15% by weight of benzyl alcohol.

The concentrate can comprise from 0.5 to 20% by weight of DMSO, from 5 to 50% by weight of benzyl alcohol and from 10 to 60% by weight of alkyl lactate (such as 2-ethylhexyl lactate). Preferably, the concentrate can comprise from 1 to 10% by weight of DMSO, from 15 to 30% by weight of benzyl alcohol and from 15 to 50% by weight of alkyl lactate (such as 2-ethylhexyl lactate).

In most cases, the concentrate is free from water. In another form, the concentrate is essentially free from water. It can comprise not more than 3% by weight, preferably not more than 1% by weight and in particular not more than 0.5% by weight of water. In special form, the concentrate may comprise not more than 0.3% by weight and in particular not more than 0.1% by weight of water.

The term pesticides refers to at least one active substance selected from the group of the fungicides, insecticides, nematicides, herbicides, safeners and/or growth regulators. Preferred pesticides are fungicides, insecticides, herbicides and growth regulators. Especially preferred pesticides are fungicides. Mixtures of pesticides from two or more of the abovementioned classes may also be used. The skilled worker is familiar with such pesticides, which can be found, for example, in Pesticide Manual, 15th Ed. (2009), The British Crop Protection Council, London. The following pesticides are suitable, by way of example (pesticides A) to K) are fungicides):

### A) Respiration Inhibitors

complex-III-inhibitors at the Qₒ-site (for example strobilurins): azoxystrobin, coumethoxystrobin, coumoxystrobin, dimoxystrobin, enestroburin, fenaminstrobin, fenoxy-strobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, methyl 2-[2-(2,5-dimethylphenyloxymethyl)phenyl]-3-methoxyacrylate, 2-(2-(3-(2,6-dichlorophenyl)-1-methylallylideneaminooxymethyl)phenyl)-2-methoxyimino-N-methylacetamide, pyribencarb, triclopyricarb/chlorodincarb, famoxadon, fenamidon;

complex-III-inhibitors at the Qᵢ-site: cyazofamid, amisulbrom;

complex-II-inhibitors (for example carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthio-biphenyl-2-yl)-3-difluoromethyl-1-methyl-1H-pyrazole-4-carboxamide, N-(2-(1,3,3-trimethylbutyl)phenyl)-1,3-dimethyl-5-fluoro-1H-pyrazole-4-carboxamide and N-[9-(dichloromethylene)-1,2,3,4-tetrahydro-1,4-methanonaphthalen-5-yl]-3-(difluoromethyl)-1-methyl-1H-pyrazole-4-carboxamide;

other respiration inhibitors (for example complex I, decouplers): diflumetorim; nitrophenyl derivatives: binapacryl, dinobuton, dinocap, fluazinam; ferimzone; organometal compounds: fentin salts such as fentin acetate, fentin chloride or fentine hydroxide; ametoctradin; and silthiofam;

### B) Sterol Biosynthesis Inhibitors (SBI Fungicides)

C14-demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, triflumizole; pyrimidines, pyridines and piperazines: fenarimol, nuarimol, pyrifenox, triforine;

delta14-reductase inhibitors: aldimorph, dodemorph, dodemorph acetate, fenpropimorph, tridemorph, fenpropidin, piperalin, spiroxamine;

3-ketoreductase inhibitors: fenhexamid;

### C) Nucleic Acid Synthesis Inhibitors

phenylamides or acylamino acid fungicides: benalaxyl, benalaxyl-M, kiralaxyl, metalaxyl, metalaxyl-M (mefenoxam), ofurace, oxadixyl;

others: hymexazole, octhilinone, oxolinic acid, bupirimate;

### D) Cell Division and Cytoskeleton Inhibitors

tubulin inhibitors such as benzimidazoles, thiophanates: benomyl, carbendazim, fuberidazole, thiabendazole, thiophanate-methyl; triazolopyrimidines: 5-chloro-7-(4-methyl-piperidin-1-yl)-6-(2,4,6-trifluorophenyl)-[1,2,4]triazolo[1,5-a]pyrimidine;

further cell division inhibitors: diethofencarb, ethaboxam, pencycuron, fluopicolid, zoxamid, metrafenon, pyriofenon;

### E) Amino Acid Synthesis and Protein Synthesis Inhibitors

methionine synthesis inhibitors (anilinopyrimidines): cyprodinil, mepanipyrim, pyrimethanil;

protein synthesis inhibitors;

### F) Signal Transduction Inhibitors

MAP/histidine kinase inhibitors: fluoroimide, iprodione, procymidone, vinclozolin, fenpiclonil, fludioxonil;

G-protein inhibitors: quinoxyfen;

### G) Lipid and Membrane Synthesis Inhibitors

phospholipid biosynthesis inhibitors: edifenphos, iprobenfos, pyrazophos, isoprothiolane;

lipid peroxidation: dicloran, quintozene, tecnazene, tolclofos-methyl, biphenyl, chloroneb, etridiazole;

phospholipid biosynthesis and cell wall attachment: dimethomorph, flumorph, mandipropamid, pyrimorph, benthiavalicarb, iprovalicarb, valifenalate and 4-fluorophenyl N-(1-(1-(4-cyanophenyl)ethanesulfonyl)but-2-yl)carbamate;

compounds which affect cell membrane permeability and fatty acids: propamocarb, propamocarb hydrochloride

### H) “Multi-site” Inhibitors

inorganic active substances: Bordeaux mixture, copper acetate, copper hydroxide, copper oxychloride, basic copper sulfate, sulfur;

thio- and dithiocarbamates: ferbam, mancozeb, maneb, metiram, propineb, thiram, zineb, ziram;

organochlorine compounds (for example phthalimides, sulfamides, chloronitriles): anilazine, chlorothalonil, captafol, captan, folpet, dichlofluanid, dichlorophen, flusulfamide, hexachlorobenzene, pentachlorophenol and its salts, phthalid, tolylfluanid, N-(4-chloro-2-nitrophenyl)-N-ethyl-4-methylbenzenesulfonamide;

guanidines and others: guanidine, dithianon;

### I) Cell Wall Biosynthesis Inhibitors

glucan synthesis inhibitors: validamycin, polyoxin B; melanin synthesis inhibitors: pyroquilon, tricyclazole, carpropamid, dicyclomet, fenoxanil;

### J) Resistance Inductors

acibenzolar-S-methyl, probenazol, isotianil, tiadinil, prohexadione-calcium; phosphonates: fosetyl, fosetyl-aluminum, phosphorous acid and its salts;

### K) Unknown Mode of Action

bronopol, quinomethionate, cyflufenamid, cymoxanil, dazomet, debacarb, diclomezin, difenzoquat, difenzoquat-methyl sulfate, diphenylamine, fenpyrazamine, flumetover, flusulfamid, flutianil, methasulfocarb, nitrapyrin, nitrothal-isopropyl, oxine-copper, proquinazid, tebufloquin, tecloftalam, triazoxide, 2-butoxy-6-iodo-3-propylchromene-4-one, N-(cyclopropylmethoxyimino-(6-difluoromethoxy-2,3-difluorophenyl)methyl)-2-phenyl-acetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)phenyl)-N-ethyl-N-methylformamidine, N′-(5-difluoromethyl-2-methyl-4-(3-trimethylsilanylpropoxy)-phenyl)-N-ethyl-N-methylformamidine, N-methyl-(1,2,3,4-tetrahydronaphthalen-1-yl)-2-{1-[2-(5-methyl-3-trifluoromethylpyrazol-1-yl)acetyl]piperidin-4-yl}thiazole-4-carboxamide, N-methyl-(R)-1,2,3,4-tetrahydronaphthalen-1-yl-2-{1-[2-(5-methyl-3-trifluoromethylpyrazol-1-yl-acetyl]piperidin-4-yl}thiazole-4-carboxamide, 1-[4-[4- [5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, 6-tert.-butyl-8-fluoro-2,3-dimethylquinolin-4-yl methoxyacetate, N-methyl-2-{1-[(5-methyl-3-trifluoromethyl-1H-pyrazol-1-yl)acetyl]piperidin-4-yl}-N-[(1R)-1,2,3,4-tetrahydronaphthalen-1-yl]-4-thiazolecarboxamide, 3-[5-(4-methylphenyl)-2,3-dimethylisoxazolidin-3-yl]-pyridine, 3-[5-(4-chlorophenyl)-2,3-dimethylisoxazolidin-3-yl]-pyridine (pyrisoxazol), N-(6-methoxypyridin-3-yl) cyclopropanecarboxamide, 5-chloro-1-(4,6-dimethoxypyrimidin-2-yl)-2-methyl-1H-benzoimidazole, 2-(4-chlorophenyl)-N-[4-(3,4-di-methoxyphenyl)isoxazol-5-yl]-2-prop-2-ynyloxyacetamide;

### M) Growth Regulators

abscisic acid, amidochlor, ancymidole, 6-benzylaminopurine, brassinolide, butralin, chlormequat (chlormequat chloride), choline chloride, cyclanilid, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidid, mepiquat (mepiquat chloride), metconazole, naphthaleneacetic acid, N-6-benzyladenine, paclobutrazole, prohexadione (prohexadione-calcium), prohydrojasmone, thidiazuron, triapenthenol, tributylphosphorotrithioate, 2,3,5-triiodobenzoic acid, trinexapac-ethyl and uniconazole;

### N) Herbicides

acetamides: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor;

amino acid analogs;

aryloxyphenoxypropionates: clodinafop, cyhalofop-butyl, fenoxaprop, fluazifop, haloxyfop, metamifop, propaquizafop, quizalofop, quizalofop-P-tefuryl;

bipyridyls;

carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;

cyclohexanediones: butroxydim, clethodim, cycloxydim, profoxydim, sethoxydim, tepraloxydim, tralkoxydim;

dinitroanilines: benfluralin, ethalfluralin, oryzalin, pendimethalin, prodiamine, trifluralin;

diphenyl ethers: acifluorfen, aclonifen, bifenox, diclofop, ethoxyfen, fomesafen, lactofen, oxyfluorfen;

hydroxybenzonitriles: bromoxynil, dichlobenil, ioxynil;

imidazolinones: imazamethabenz, imazamox, imazapic, imazapyr, imazaquin, imazethapyr;

phenoxyacetic acids: clomeprop, 2,4-dichlorophenoxyacetic acid (2,4-D), 2,4-DB, dichlorprop, MCPA, MCPA-thioethyl, MCPB, mecoprop;

pyrazines: chloridazon, flufenpyr-ethyl, fluthiacet, norflurazon, pyridate;

pyridines: aminopyralid, clopyralid, diflufenican, dithiopyr, fluridone, fluroxypyr, picloram, picolinafen, thiazopyr;

sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl)sulfonyl)-3-(4,6-dimethoxypyrimidin-2-yl)urea;

triazines: ametryne, atrazine, cyanazine, dimethametryne, ethiozine, hexazinone, metamitron, metribuzine, prometryne, simazine, terbuthylazine, terbutryne, triaziflam;

ureas: chlortoluron, daimuron, diuron, fluometuron, isoproturon, linuron, methabenzthiazuron, tebuthiuron;

other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam;

others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethyl, chlorthal, cinmethylin, clomazone, cumyluron, cyprosulfamid, dicamba, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, tembotrione, thiencarbazone, topramezone, 4-hydroxy-3-[2-(2-methoxyethoxy-methyl)-6-trifluoromethylpyridin-3-carbonyl]bicyclo[3.2.1]oct-3-en-2-one, ethyl (3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6-amino-5-chloro-2-cyclopropylpyrimidine-4-carboxylate, 6-chloro-3-(2-cyclopropyl-6-methylphenoxy)pyridazin-4-ol, 4-amino-3-chloro-6-(4-chlorophenyl)-5-fluoropyridin-2-carboxylic acid, methyl 4-amino-3-chloro-6-(4-chloro-2-fluoro-3-methoxy-phenyl)pyridin-2-carboxylate and methyl 4-amino-3-chloro-6-(4-chloro-3-dimethylamino-2-fluorophenyl)pyridin-2-carboxylate;

### O) Insecticides

organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;

carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin,

insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazin; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;

nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl-[1,3,5]triazinane;

GABA antagonists: endosulfan, ethiprole, fipronil, vaniliprole, pyrafluprole, pyriprole, N-5-amino-1-(2,6-dichloro-4-methylphenyl)-4-sulfinamoyl-1H-pyrazole-3-thiocarboxamide;

macrocyclic lactones: abamectin, emamectin, milbemectin, lepimectin, spinosad, spinetoram;

mitochondrial electron transport chain inhibitor (METI) I acaricides: fenazaquin, pyridaben, tebufenpyrad, tolfenpyrad, flufenerim;

METI II and III substances: acequinocyl, fluacyprim, hydramethylnone;

decouplers: chlorfenapyr;

inhibitors of oxidative phosphorylation: cyhexatin, diafenthiuron, fenbutatin oxide, propargite;

insect ecdysis inhibitors: cryomazine;

‘mixed function oxidase’ inhibitors: piperonyl butoxide;

sodium channel blockers: indoxacarb, metaflumizone;

others: benclothiaz, bifenazate, cartap, flonicamid, pyridalyl, pymetrozin, sulfur, thiocyclam, flubendiamide, chlorantraniliprole, cyazypyr (HGW86); cyenopyrafen, flupyrazofos, cyflumetofen, amidoflumet, imicyafos, bistrifluron and pyrifluquinazone.

The pesticide is water-insoluble. Usually, it is soluble in water to not more than 1 g/l, preferably to not more than 200 mg/l and in particular to not more than 50 mg/l at 25° C. Examples of water-insoluble pesticides are fluxapyroxad. Using simple preliminary experiments, the skilled worker can select a pesticide with a suitable water-solubility from the above pesticide list.

The pesticide can have a melting point of more than 40° C., preferably more than 70° C. and in particular more than 90° C.

The pesticide is preferably present in the concentrate in dissolved form. Using simple preliminary experiments, the skilled worker can select, from the above pesticide list, a pesticide with a suitable solubility.

In addition to the water-insoluble pesticide, the concentrate can comprise one or more further pesticides. The further pesticide is preferably water-insoluble. Usually, it is soluble in water to not more than 1 g/l, preferably to not more than 200 mg/l and in particular to not more than 50 mg/l at 25° C. Using simple preliminary experiments, the skilled worker can select a pesticide with a suitable water-solubility from the above pesticide list. In an especially preferred form, the concentrate does not comprise any further pesticide. In another especially preferred form, the further pesticide is epoxiconazol.

In a preferred form the concentrate comprises the water insoluble pesticide fluxapyroxad and optionally a further pesticide, which is water insoluble (e.g. epoxiconazol).

The concentrate may comprise from 0.1 to 60% by weight, preferably from 1 to 25% by weight, in particular from 5 to 15% by weight, of pesticide, the basis being the total of all the pesticides present in the concentrate.

The emulsifiable concentrate can furthermore comprise auxiliaries conventionally used for crop protection products. Suitable auxiliaries are solvents, liquid carriers, surfactants, dispersants, emulsifiers, wetters, adjuvants, solubilizers, penetrants, protective colloids, stickers, thickeners, bactericides, antifreeze agents, antifoam agents, colorants, adhesives and binders.

Suitable solvents and liquid carriers are organic solvents such as mineral oil fractions with medium to high boiling point, for example kerosene, diesel oil; oils of vegetable or animal origin; aliphatic, cyclic and aromatic hydrocarbons, for example toluene, paraffin, tetrahydro-naphthalene, alkylated naphthalenes; alcohols, for example ethanol, propanol, butanol, cyclohexanol; glycols; ketones, for example cyclohexanone; esters, for example lactates, carbonates, fatty acid esters, gamma-butyrolactone; fatty acids; phosphonates; amines; amides, for example N-methylpyrrolidone, fatty acid dimethyl amides; and their mixtures.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetrant, protective colloid, or auxiliary. Examples of surfactants are listed in McCutcheon's, Vol.1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates. Preferred anionic surfactants are sulfates and sulfonates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate. Preferred nonionic surfactants are alkoxylates. Nonionic surfactants such as alkoxylates may also be employed as adjuvants.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds which have negligible or even no pesticidal activity themselves, and which improve the biological performance of the compound I on the target. Examples are surfactants, mineral or vegetable oils, and other auxilaries. Further examples are listed by Knowles, Adjuvants and Additives, Agrow Reports DS256, T&F Informa UK, 2006, chapter 5.

Suitable bactericides are bronopol and isothiazolinone derivatives such as alkylisothiazolinones, chloroisothiazolinones and benzisothiazolinones. Suitable antifreeze agents are ethylene glycol, propylene glycol, urea and glycerol. Suitable antifoam agents are silicones, long-chain alcohols, and salts of fatty acids. Suitable colorants (e.g. in red, blue, or green) are pigments which are sparingly soluble in water, and water-soluble dyes. Examples are inorganic colorants (e.g. iron oxide, titanium oxide, iron hexacyanoferrate) and organic colorants (e.g. alizarin, azo and phthalocyanine colorants).

The concentrate preferably comprises at least one anionic surfactant. The concentrate usually comprises not less than 0.5% by weight of anionic surfactants, preferably not less than 2% by weight and in particular not less than 3% by weight. The composition can comprise not more than 30% by weight of anionic surfactants, preferably not more than 15% by weight and in particular not more than 10% by weight.

The concentrate preferably comprises at least one nonionic surfactant (such as alkoxylates, especially alkoxylated alcohols). The concentrate usually comprises not less than 1% by weight of nonionic surfactants, preferably not less than 5% by weight and in particular not less than 10% by weight. The composition can comprise not more than 65% by weight of nonionic surfactants, preferably not more than 45% by weight and in particular not more than 35% by weight.

In a preferred form, the concentrate preferably comprises at least one alkoxylate, in particular an alkoxylated C6-C22-alcohol. The concentrate usually comprises not less than 2% by weight of alkoxylates (in particular an alkoxylated C6-C22-alcohol), preferably not less than 7% by weight and in particular not less than 10% by weight.

Preferably, the concentrate comprises a nonionic surfactant (such as alkoxylates) and an anionic surfactant (such as sulfates or sulfonates).

The invention furthermore relates to a process for the preparation of the emulsifiable concentrate according to the invention by mixing the water-insoluble pesticide, not more than 40% by weight of dimethyl sulfoxide, benzyl alcohol and alkyl lactate. In most cases, the pesticide will be dissolved in the solvent upon mixing.

The invention furthermore relates to an emulsion obtainable (preferably obtained) by mixing water with the emulsifiable concentrate according to the invention. The emulsion normally arises spontaneously upon mixing. In most cases, the emulsion is an oil-in-water emulsion. The mixing ratio of water to concentrate can be in the range of from 1000 to 1 up to 1 to 1, preferably 200 to 1 up to 3 to 1.

The invention furthermore relates to a method for controlling phytopathogenic fungi and/or undesired vegetation and/or undesired attack by insects or mites and/or for regulating the growth of plants, where the concentrate according to the invention or the emulsion according to the invention is allowed to act on the respective pests, their environment or on the crop plants to be protected from the respective pests, on the soil and/or on undesired plants and/or on the crop plants and/or their environment. In general, the therapeutic treatment of humans and animals is excluded from the method for controlling phytopathogenic fungi and/or undesired vegetation and/or undesired attack by insects or mites and/or for regulating the growth of plants.

When employed in crop protection, the application rates of the pesticides amount to from 0.001 to 2 kg per ha, preferably from 0.005 to 2 kg per ha, more preferably from 0.05 to 0.9 kg per ha and in particular from 0.1 to 0.75 kg per ha, depending on the nature of the desired effect. In treatment of plant propagation materials such as seeds, e. g. by dusting, coating or drenching seed, amounts of active substance of from 0.1 to 1000 g, preferably from 1 to 1000 g, more preferably from 1 to 100 g and in particular from 5 to 100 g, per 100 kg of plant propagation material (preferably seed) are generally required. When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizers or micronutrients and further pesticides (for example herbicides, insecticides, fungicides, growth regulators, safeners) may be added to the emulsion in the form of a premix or optionally only shortly before use (tank mix). These agents can be admixed to the compositions according to the invention at a weight ratio of from 1:100 to 100:1, preferably from 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Advantages of the present invention are, inter alia, that the concentrate is highly stable to low temperatures (e.g. even below 0° C.); that the pesticide does not precipitate, cream or crystallize in the concentrate at low temperatures (e.g. even below 0° C.); that high pesticide concentrations in the concentrate can be employed; that an emulsion forms spontaneously upon dilution of the concentrate with water; that the concentrate is capable of being stored over prolonged periods; that the concentrate does not require the presence of water (e.g. because it might freeze below 0 ° C. or would favour bacterial growth during storage); that the concentrate forms a stable emulsion upon dilution with water; that the concentrate ; or that adjuvants (such as alcohol alkoxylates) can be included in the concentrate formulations.

The examples which follow illustrate the invention without imposing any limitation.

### EXAMPLES

DMA: dimethyl adipate

BenzOH: benzyl alcohol

Al1: fluxapyroxad

Al2: epoxiconazole

Al3: pyraclostrobin

NS1: nonionic surfactant, liquid ethoxylated polyalkylarylphenol, HLB 12-13.

NS2: nonionic surfactant, liquid alkoxylated fatty alcohol, surface tension (1 g/l, 23° C.) 28-30 mN/m; Brookfield viscosity (23° C.) 70-80 mPas.

AS1: calcium tetrapropylenebenzenesulfonate, 40% by weight in aromatic solvent.

AS2: polyarylphenylethyl sulfate, acid number 39-52 mg KoH/g.

### Example 1-11

### Preparation of Emulsion Concentrates

The emulsifiable concentrates of fluxapyroxad (in each case 62.5 g/l) were prepared by mixing the components and making up to 1.0 l with (S)-2-ethylhexyl lactate.

TABLE 1
Composition of examples 1-11 (all data in g/l)

| Example | BenzOH | DMSO | DMA | AS1 | NS1 | NS2 | NS3 |
|---|---|---|---|---|---|---|---|
| 1 | 200 | 30 | 50 | 50 | 50 | 150 | 50 |
| 2 | 100 | 30 | 50 | 50 | 50 | 250 | 50 |
| 3 | 200 | 50 | 100 | 50 | 50 | 100 | 75 |
| 4 | 200 | 30 | 100 | 25 | 25 | 100 | 100 |
| 5 | 200 | 30 | 50 | 50 | 50 | 150 | 50 |
| 6 | 200 | 30 | 50 | 100 | 50 | 150 | 50 |
| 7 | 200 | 30 | 50 | 140 | 30 | 150 | 50 |
| 8 | 200 | 30 | 50 | 70 | 50 | 150 | 150 |
| 9 | 200 | 60 | 100 | 50 | 50 | 150 | 50 |
| 10 | 200 | 60 | 150 | 50 | 50 | 150 | 50 |
| 11 | 200 | 30 | 100 | 75 | 75 | 100 | 50 |

### Example 12-25

### Preparation of Emulsion Concentrates

The emulsifiable concentrates in Table 2 were prepared by mixing the components and making up to 1.0 l with (S)-2-ethylhexyl lactate.

TABLE 2
Composition of examples 12-16 (all data in g/l)

| Example | Al1 | Al2 | Al3 | BenzOH | DMSO | AS1 | AS2 | NS1 | NS2 |
|---|---|---|---|---|---|---|---|---|---|
| 12 | 63 | 63 | — | 250 | 50 | 75 | — | 75 | — |
| 13 | 63 | 63 | — | 250 | 50 | 90 | — | 60 | 150 |
| 14 | 63 | 63 | — | 250 | 50 | 60 | — | 90 | 150 |
| 15 | 63 | 63 | — | 250 | 50 | 45 | — | 105 | 150 |
| 16 | 63 | 63 | — | 250 | 50 | 30 | — | 120 | 150 |
| 17 | 63 | 63 | — | 250 | 50 | 15 | — | 135 | 150 |
| 18 | 59 | 63 | — | 250 | 50 | 75 | — | 75 | — |
| 19 | 50 | 50 | 81 | 200 | 30 | — | 50 | 100 | 200 |
| 20 | 50 | 50 | 81 | 250 | — | 75 | — | 75 | — |
| 21 | 50 | 50 | 81 | 250 | 30 | 75 | — | 75 | — |
| 22 | 50 | 50 | 81 | 250 | 30 | 75 | — | 75 | 150 |
| 23 | 50 | 50 | 81 | 250 | 30 | — | 50 | 50 | — |
| 24 | 42 | 42 | 67 | 200 | 30 | — | 50 | 100 | 200 |
| 25 | 42 | 42 | 61 | 200 | 30 | — | 50 | 100 | 200 |

1-16. (canceled)

17. An emulsifiable concentrate comprising a water-insoluble pesticide, benzyl alcohol, alkyl lactate and not more than 40% by weight of dimethyl sulfoxide.

18. The emulsifiable concentrate according to claim 17, comprising not more than 20% by weight of dimethyl sulfoxide.

19. The emulsifiable concentrate according to claim 17, comprising not less than 30% by weight of 2-alkyl lactate.

20. The emulsifiable concentrate according to claim 17, comprising not more than 50% by weight of benzyl alcohol.

21. The emulsifiable concentrate according to claim 17, comprising 0.5 to 20% by weight of DMSO, 5 to 50% by weight of benzyl alcohol and 10 to 60% by weight of alkyl lactate.

22. The emulsifiable concentrate according to claim 17, comprising 1 to 10% by weight Of DMSO, 15 to 30% by weight of benzyl alcohol and 15 to 50% by weight of alkyl lactate.

23. The emulsifiable concentrate according to claim 17, comprising a nonionic and an anionic surfactant.

24. The emulsifiable concentrate according to claim 17, wherein the alkyl lactate is 2-ethylhexyl lactate.

25. The emulsifiable concentrate according to claim 17, wherein the concentrate is present as a homogeneous solution.

26. The emulsifiable concentrate according to claim 17, wherein the pesticide is soluble in water to not more than 1 g/l at 25° C.

27. The emulsifiable concentrate according to claim 17, wherein the pesticide has a melting point of above 40° C.

28. The emulsifiable concentrate according to claim 17, wherein the concentrate comprises not more than 3% by weight of water.

29. The emulsifiable concentrate according to claim 17, wherein the pesticide is fluxapyroxad.

30. A method for controlling phytopathogenic fungi and/or undesired vegetation and/or undesired attack by insects or mites and/or for regulating the growth of plants, where the concentrate according to claim 17 is allowed to act on the respective pests, their environment or on the crop plants to be protected from the respective pests, on the soil and/or on undesired plants and/or on the crop plants and/or their environment.

31. The method according to claim 30, wherein said mixture comprises not more than 20% by weight of dimethyl sulfoxide.

32. The method according to claim 30, wherein said mixture comprises not less than 30% by weight of 2-alkyl lactate.

33. The method according to claim 30, wherein said mixture comprises not more than 50% by weight of benzyl alcohol.

34. The method according to claim 30, wherein said mixture comprises 0.5 to 20% by weight of DMSO, 5 to 50% by weight of benzyl alcohol and 10 to 60% by weight of alkyl lactate.

35. The method according to claim 30, wherein said mixture comprises 1 to 10% by weight of DMSO, 15 to 30% by weight of benzyl alcohol and 15 to 50% by weight of alkyl lactate.

36. The method according to claim 30, wherein said mixture comprises a nonionic and an anionic surfactant.
